(19) United States
(12) Patent Application Publication
(10) Pub. No.: US 2025/0021275 A1
(43) Pub. Date: Jan. 16, 2025

(54) PRINTING DEVICE, CONTROL METHOD THEREFOR, AND NON-TRANSITORY COMPUTER-READABLE STORAGE MEDIUM

(71) Applicant: BROTHER KOGYO KABUSHIKI KAISHA, Nagoya (JP)

(72) Inventors: Kodai MIZUNO, Hekinan (JP); Hitomi MIWA, Nagoya (JP); Shota MORIKAWA, Nagoya (JP)

(21) Appl. No.: 18/899,683

(22) Filed: Sep. 27, 2024

Related U.S. Application Data
(63) Continuation of application No. PCT/JP2023/010591, filed on Mar. 17, 2023.

(30) Foreign Application Priority Data
Mar. 31, 2022 (JP) 2022-060444

(51) Int. Cl. G06F 3/12; G06K 15/02; G06K 15/10

(52) U.S. Cl. CPC G06F 3/1208; G06F 3/1256; G06K 15/102; G06K 15/1878

(57) ABSTRACT

A printing apparatus includes: a display device; a controller; and a memory configured to store computer-readable instructions, including: a first acquisition operation of acquiring first image data for printing a first image on a printing medium using an ink ejected from a nozzle; a first color conversion operation of performing color conversion on the first image data to generate second image data; a second color conversion operation of performing, according to a display condition when displaying the first image on the display device, color conversion on the second image data to generate third image data; and a display operation of displaying a second image on the display device based on the third image data. In the first color conversion operation, the color conversion is performed according to any one of a printing medium, a printing condition, and a combination of the printing medium and the printing condition.

### REFERENCE TO RELATED APPLICATIONS

This is a continuation application of International Application No. PCT/JP2023/010591 filed on Mar. 17, 2023, which claims priority from Japanese Patent Application No. 2022-060444 filed on Mar. 31, 2022. The entire contents of the aforementioned applications are incorporated herein by reference.

### BACKGROUND ART

As a printing apparatus in a related art, for example, an image processing apparatus is known. The image processing apparatus performs, on an image data, a color correction process corresponding to an output object observation environment when observing a printed image printed by a printer and corresponding to a display object observation environment when observing a simulation image displayed on a monitor. The image processing apparatus displays the simulation image on the monitor based on the image data subjected to the color correction process.

The image processing apparatus performs color correction on the image data based on the observation environment of the printed image and the simulation image. In the observation environment, it may be difficult to adequately simulate a printed image.

### SUMMARY

In view of such a situation, an object of the present disclosure is to provide a printing apparatus capable of improving the accuracy of simulating a printed image, a control method for the printing apparatus, a computer program, and a printing system.

A printing apparatus includes: a display device; a controller; and a memory configured to store computer-readable instructions that, when executed by the controller, perform processes including: a first acquisition operation of acquiring first image data for printing a first image on a printing medium using an ink ejected from a nozzle; a first color conversion operation of performing color conversion on the first image data to generate second image data; a second color conversion operation of performing, according to a display condition when displaying the first image on the display device, color conversion on the second image data to generate third image data; and a display operation of displaying a second image on the display device based on the third image data. In the first color conversion operation, the color conversion is performed according to any one of a printing medium, a printing condition, and a combination of the printing medium and the printing condition.

A control method for a printing apparatus according to an aspect of the present disclosure includes: causing a printing apparatus including a display device to execute a first acquisition operation of acquiring first image data for printing a first image on a printing medium using an ink ejected from a nozzle, a first color conversion operation of performing color conversion on the first image data to generate second image data, a second color conversion operation of performing, according to a display condition when displaying the first image on the display device, color conversion on the second image data to generate third image data, and a display operation of displaying a second image on the display device based on the third image data. In the first color conversion operation, the color conversion is performed according to any one of the printing medium, a printing condition, and a combination of the printing medium and the printing condition.

A non-transitory computer readable storage medium storing a computer program according to an aspect of the present disclosure causes a computer of a printing apparatus including a display device, the program including: a first acquisition operation of acquiring first image data for printing a first image on a printing medium using an ink ejected from a nozzle; a first color conversion operation of performing color conversion on the first image data to generate second image data; a second color conversion operation of performing, according to a display condition when displaying the first image on the display device, color conversion on the second image data to generate third image data; and a display operation of displaying a second image on the display device based on the third image data. In the first color conversion operation, the color conversion is performed according to any one of the printing medium, a printing condition, and a combination of the printing medium and the printing condition.

According to the present disclosure, it is possible to provide a printing apparatus capable of improving the accuracy of simulating a printed image, a control method for the printing apparatus, a computer program, and a printing system.

The above objects, other objects, features, and advantages of the present disclosure will become apparent from the following detailed description of preferred embodiments with reference to the accompanying drawings.

### BRIEF DESCRIPTION OF DRAWINGS

FIG. 1 is a schematic diagram of a printing apparatus according to an embodiment and modifications of the present disclosure when viewed from above.

FIG. 2 is a schematic diagram of a head of FIG. 1 as viewed from below.

FIG. 3 is a block diagram showing a functional configuration of the printing apparatus according to Embodiments 1 and 2 and modifications thereof.

FIG. 4 is a flowchart showing an example of a control method for the printing apparatus according to Embodiment 1 and Modifications 1 to 6.

FIG. 5 is a diagram showing a first image to be printed on a printing medium.

FIG. 6A is a diagram showing a patch chart printed on the printing medium. FIG. 6B is a diagram showing a patch chart displayed on a display device.

FIG. 7A is a graph showing an a-b plane of the first image when L=0 in an L*a*b* color space. FIG. 7B is a graph showing an L-a plane of the first image when b=0 in the L*a*b* color space. FIG. 7C is a graph showing an L-b plane of the first image when a=0 in the L*a*b* color space.

FIG. 8A is a graph showing the a-b plane of the first image when L=0 in the L*a*b* color space. FIG. 8B is a graph showing the L-a plane of the first image when b=0 in the L*a*b* color space. FIG. 8C is a graph showing the L-b plane of the first image when a=0 in the L*a*b* color space.

FIG. 9 is a flowchart showing an example of a control method for a printing apparatus according to Modification 7.

FIG. 10A is a diagram showing a display device that displays a second image in which portions outside the print color gamut are expressed by shading of a spot color. FIG. 10B is a diagram showing the display device that displays the second image in which portions outside the print color gamut are expressed by color differences.

FIG. 11 is a flowchart showing an example of a control method for a printing apparatus according to Embodiment 2.

FIG. 12 is a flowchart showing an example of a control method for a printing apparatus according to Modification 8.

FIG. 13 is a block diagram showing a functional configuration of a printing system according to Embodiment 3.

FIG. 14 is a flowchart showing an example of a control method for the printing system of FIG. 13.

### DESCRIPTION

### Embodiment 1

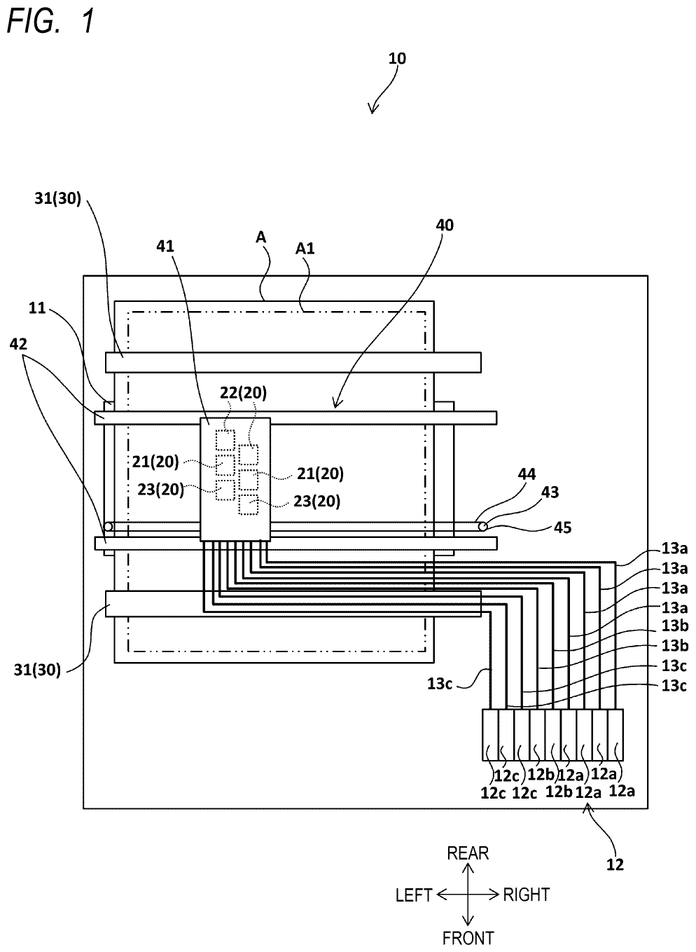

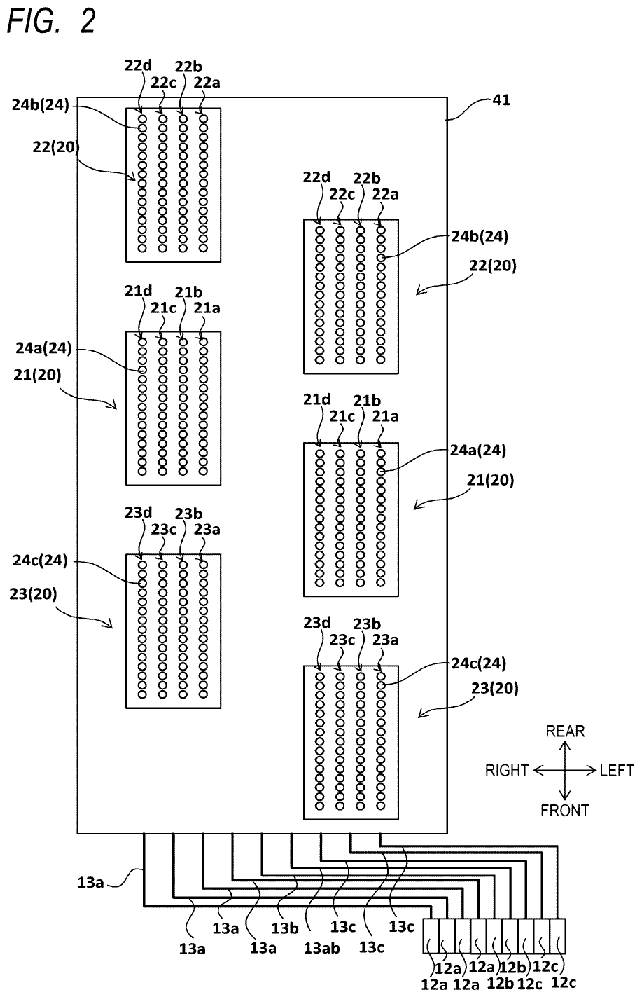

As shown in FIG. 1, a printing apparatus 10 according to Embodiment 1 of the present disclosure is a device in which ink is ejected from a nozzle 24 (FIG. 2) of a head 20 onto a printing medium A, and an image is printed on the printing medium A using the ink. In the following, an example in which the printing apparatus 10 is applied to an ink jet printer will be described. The printing medium A is, for example, a sheet such as paper or cloth.

The printing apparatus 10 is of a serial head system and includes a plurality of heads 20, a platen 11, a plurality of tanks 12, a conveying device 30, and a scanning device 40. A direction in which the printing medium A is conveyed by the conveying device 30 is referred to as a front-rear direction. A direction that intersects with (for example, orthogonal to) the front-rear direction and in which the head 20 is moved by the scanning device 40 is referred to as a left-right direction. A direction that intersects with (for example, orthogonal to) the front-rear direction and the left-right direction is referred to as an upper-lower direction. The arrangement of the printing apparatus 10 is not limited thereto. The printing apparatus 10 may also be of a line head type. In this case, the printing apparatus 10 does not include the scanning device 40, and the head 20 does not move and has a dimension longer than a length of a printing region A1 of the printing medium A in the left-right direction.

The plurality of heads 20 include a first head 21, a second head 22, and a third head 23. The head 20 may include at least one of the first head 21, the second head 22, and the third head 23. The platen 11 has a flat upper surface, and defines a distance between a surface of the printing medium A disposed on the upper surface and a lower surface of the head 20 provided opposite thereto. The tanks 12 are containers for storing ink, and the number of the tanks 12 is equal to or greater than the number of types of ink. The tanks 12 includes, for example, a first tank 12a, a second tank 12b, and a third tank 12c.

The first tank 12a stores ink of a predetermined basic color, communicates with the first head 21 through a first flow path 13a, and supplies the ink to the first head 21 via the first flow path 13a. The basic colors include cyan, yellow, magenta, and black.

The second tank 12b stores, for example, a base ink and a pre-processing liquid, communicates with the second head 22 through a second flow path 13b, and supplies the base ink and the pre-processing liquid to the second head 22 via the second flow path 13b. An example of a base color, which is the color of the base ink, is white. The pre-processing liquid is a solution suited to the type of the ink and the printing medium A, for example, an aqueous solution containing a polyvalent metal salt, and is used for pre-processing before a printing operation.

The third tank 12c stores, for example, a spot color ink and a post-processing liquid, communicates with the third head 23 through a third flow path 13c, and supplies the spot color ink and the post-processing liquid to the third head 23 via the third flow path 13c. The spot color is a color different from the basic color ink, and examples thereof include chromatic colors such as red, green, blue, and violet. The post-processing liquid is a solution suited to the type of the ink and the printing medium A, for example, an aqueous solution containing a resin, and is used for post-processing after the printing operation.

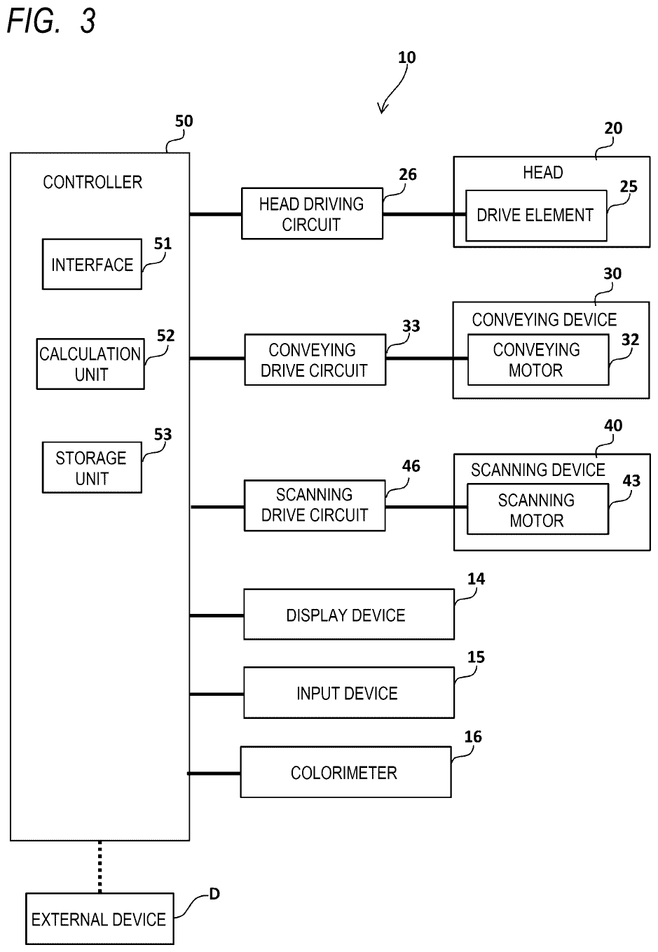

The conveying device 30 includes, for example, two conveying rollers 31 and a conveying motor 32 (FIG. 3). The two conveying rollers 31 are arranged in the front-rear direction with the platen 11 sandwiched therebetween. The conveying rollers 31 each have an axis extending in the left-right direction and are coupled to the conveying motor 32. The conveying roller 31 rotates about the axis when driven by the conveying motor 32, and conveys the printing medium A in the front-rear direction on the platen 11.

The scanning device 40 includes a carriage 41, two guide rails 42, a scanning motor 43, and an endless belt 44. The two guide rails 42 extend in the left-right direction above the platen 11 so as to sandwich the head 20 therebetween in the front-rear direction. The carriage 41 carries the head 20 and is supported by the two guide rails 42 so as to be movable in the left-right direction. The endless belt 44 extends in the left-right direction and is attached to the carriage 41 and also to the scanning motor 43 via a pulley 45. The endless belt 44 runs when driven by the scanning motor 43, and the carriage 41 reciprocates in the left-right direction along the guide rails 42. Thus, the carriage 41 moves the head 20 in the left-right direction.

### Head

As shown in the example of FIG. 2, the carriage 41 is provided with the first head 21 on a right side and the first head 21 on a left side, the second head 22 on the right side and the second head 22 on the left side, and the third head 23 on the right side and the second head 23 on the left side. For example, the second head 22 on the right side, the first head 21 on the right side, and the third head 23 on the right side are arranged in a row in the front-rear direction with a gap therebetween in that order. The second head 22 on the left side, the first head 21 on the left side, and the third head 23 on the left side are arranged in a row in the front-rear direction with a gap therebetween in that order. The heads 20 are arranged in a staggered manner in the front-rear direction and the left-right direction.

The plurality of nozzles 24 include a first nozzle 24a of the first head 21, a second nozzle 24b of the second head 22, and a third nozzle 24c of the third head 23. The nozzles 24 open on a lower surface of respective heads 20. The plurality of nozzles 24 are aligned in the front-rear direction in respective heads 20 to form a nozzle row. The plurality of nozzle rows are provided in parallel with each other at intervals in the left-right direction in respective heads 20. The nozzle rows of the first head 21 include first nozzle rows 21a to 21d, the nozzle rows of the second head 22 include second nozzle rows 22a to 22d, and the nozzle row of the third head 23 include third nozzle rows 23a to 23d.

The first nozzle 24a of the first nozzle row 21a communicates with the first tank 12a of cyan ink. The first nozzle 24a of the first nozzle row 21b communicates with the first tank 12a of magenta ink. The first nozzle 24a of the first nozzle row 21c communicates with the first tank 12a of yellow ink. The first nozzle 24a of the first nozzle row 21d communicates with the first tank 12a of black ink. The second nozzles 24b of the second nozzle rows 22a to 22b communicate with the second tank 12b of the pre-processing liquid. The second nozzles 24b of the second nozzle rows 22c to 22d communicate with the second tank 12b of the base ink. The third nozzles 24c of the third nozzle rows 23a to 23b communicate with the third tank 12c of the spot color ink. The third nozzles 24c of the third nozzle rows 23c to 23d communicate with the third tank 12c of the post-processing liquid.

As shown in FIG. 3, the head 20 includes a plurality of drive elements 25. The drive element 25 is a piezoelectric element, a heat generating element, an electrostatic actuator, or the like, is provided for each nozzle 24, and applies pressure to the ink to eject the ink from the nozzle 24.

### Controller, Display Device, Input Device, and Colorimeter

As shown in FIG. 3, the printing apparatus 10 further includes a display device 14, an input device 15, a colorimeter 16, and a controller 50. The controller 50 is, for example, a computer, and includes an interface 51, a calculation unit 52, and a storage unit 53. The interface 51 receives various data such as image data from an external device D such as a computer, a camera, a communication network, a recording medium, a display, and a printer. The image data is raster data indicating an image to be printed on the printing medium A. The controller 50 may be implemented by a single device, or may have a configuration in which a plurality of devices are arranged in a distributed manner and cooperate with each other to operate the controller 50.

The storage unit 53 is a memory accessible from the calculation unit 52 and includes a RAM and a ROM. The RAM temporarily stores various data including data received from the external device D such as image data, data converted by the calculation unit 52, and the like. The ROM stores a computer program for performing various data processing, predetermined data such as a predetermined correspondence relationship, and the like. The computer program may be stored in an external storage medium different from the storage unit 53 and accessible from the calculation unit 52, such as a CDROM.

The calculation unit 52 includes at least one circuit, for example, a processor such as a CPU, and an integrated circuit such as an ASIC. The calculation unit 52 controls each unit by executing the computer program, and executes various operations such as an acquisition operation, a color conversion operation, a display operation, and a printing operation. Details of various operations will be described later.

The controller 50 is electrically connected to the display device 14, the input device 15, and the colorimeter 16. The display device 14 is, for example, a display or the like, and displays an image or the like to be printed by the printing operation under the control of the controller 50. The input device 15 is, for example, a button, a mouse, or the like, is operated by a user to input data to the controller 50. The input device 15 may be a touch panel integrated with the display device 14. The input device 15 may be an interface 51 to which information is input from the outside. The colorimeter 16 is, for example, a spectrophotometer, which measures the color of a patch P and the like, and inputs the measured color to the controller 50.

Further, the controller 50 is electrically connected to the drive element 25 via a head driving circuit 26. The controller 50 outputs a control signal of the drive element 25 to the head driving circuit 26. The head driving circuit 26 generates a drive signal based on the control signal and outputs the drive signal to the drive element 25. The drive element 25 is driven according to the drive signal, and ink is ejected from the nozzle 24.

The controller 50 is electrically connected to the conveying motor 32 of the conveying device 30 via a conveying drive circuit 33, and controls driving of the conveying motor 32. Accordingly, the conveyance of the printing medium A by the conveying device 30 is controlled. Further, the controller 50 is electrically connected to the scanning motor 43 of the scanning device 40 via a scanning drive circuit 46, and controls driving of the scanning motor 43. Thus, the movement of the head 20 by the scanning device 40 is controlled.

### Printing Operation

In such a printing apparatus 10, the controller 50 acquires image data of an image and executes a printing operation based on the image data. In this printing operation, the controller 50 ejects a liquid such as ink from the head 20 onto the printing medium Awhile moving the head 20 to the right or left in a pass process. Then, the controller 50 causes the printing medium A to be conveyed forward in a conveying process. In this way, the printing apparatus 10 advances the printing operation by alternately repeating the path process and the conveying process.

The printing operation includes image printing, and may include at least one of base printing, pre-processing, and post-processing. The pre-processing is executed before the printing operation. In the pre-processing, the controller 50 causes the pre-processing liquid to be ejected onto the printing medium A from the second nozzle 24b of the second head 22, so that a pre-processed layer is formed on the printing medium A using the pre-processing liquid. Then, the pre-processed layer is subjected to heat treatment using a heat press plate, an oven, a hot air blower, or the like. When the base printing or the image printing is performed after such pre-processing, the ink lands on the pre-processed layer, and the pre-processed layer bonds the printing medium A to the ink, making it easier for the ink to be fixed to the printing medium A.

In the base printing, the controller 50 acquires a base range based on the image data or a predetermined base range. Then, the controller 50 causes the second nozzle 24b of the second head 22 to eject the base ink onto the base range of the printing medium A, and forms a base made of the base ink on the surface of the printing medium A or on a pre-processed layer.

In the image printing, the controller 50 executes at least one of an ejection operation for ejecting a basic color ink from the first nozzle 24a of the first head 21, and an ejection operation for ejecting a spot color ink from the third nozzle 24c of the third head 23, based on the image data of the image. As a result, an image is formed with the ink on the surface of the printing medium A or on the pre-processed layer or on the base.

The post-processing is executed after the printing operation. In the post-processing, the controller 50 causes the third nozzle 24c of the third head 23 to eject the post-processing liquid. Thus, the post-processing liquid lands on the image formed by image printing, and a post-processed layer is formed by the post-processing liquid. Then, the post-processed layer is subjected to heat treatment using a heat press plate, an oven, a hot air blower, or the like. Such a post-processed layer is transparent, for example, and the image is easily fixed to the printing medium A.

### Control Method for Printing Apparatus

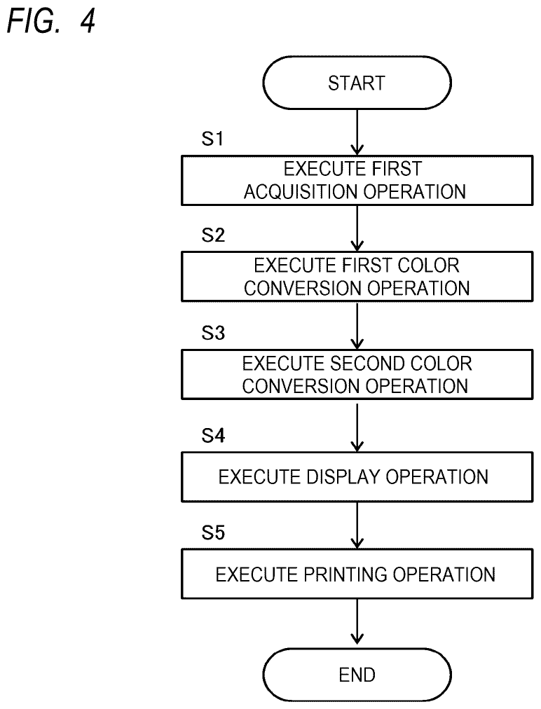

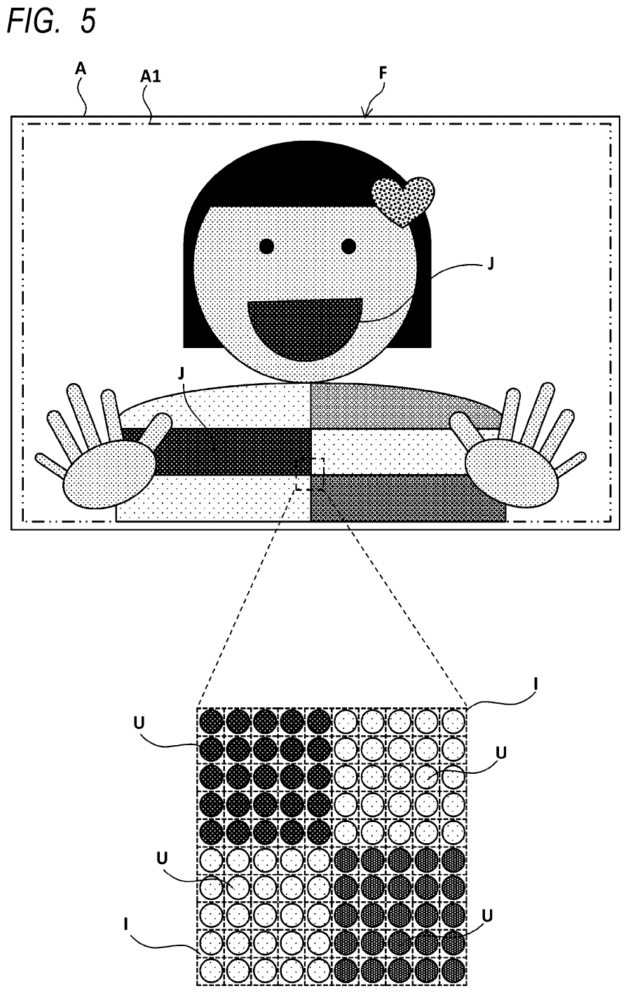

A control method for the printing apparatus 10 is executed by the controller 50, for example, according to a flowchart of FIG. 4, which shows an example of the control method. For example, when receiving a print job, the controller 50 executes each process according to the flowchart. The controller 50 executes a first acquisition operation to acquire first image data for printing a first image F of the example of FIG. 5 on the printing medium A with ink ejected from the nozzle 24 (step S1).

The first image data is input data input to the controller 50 and is expressed by color values in a predetermined color space. The color values correspond to pixels I, which are a plurality of regions obtained by dividing the first image F into unit areas. The color values are expressed, for example, as color coordinates in a device-dependent color space, such as RGB values in an RGB color space. The RGB value represents one color by combining, for example, a 256 gradation red color value, a 256 gradation green color value, and a 256 gradation blue color value.

Next, the controller 50 executes a first color conversion operation for generating second image data by performing color conversion on the first image data (step S2). In the first color conversion operation, the controller 50 performs color conversion according to any one of the printing medium A, printing conditions, and a combination of the printing medium A and the printing conditions.

Specifically, the controller 50 acquires printing information of at least one of the printing medium A and the printing conditions. The printing information is acquired from any one of the external device D, the storage unit 53, and the input device 15.

The printing information of the printing medium A is an element related to the printing medium A that affects the color of the image printed on the printing medium A. For example, the printing information of the printing medium A includes the type and color of the printing medium A, the amount and concentration of the pre-processing liquid and the post-processing liquid, and the fixing method in the pre-processing and the post-processing. The type of printing medium A includes, for example, the material and shape of the printing medium A. The materials for the printing medium A include, for example, paper, resins such as polyester, and fabrics such as cotton. The form of the printing medium A may be, for example, woven fabric, knitted fabric, nonwoven fabric, or the like. The colors of the printing medium A include, for example, white and black.

The amount of the pre-processing liquid is the total amount of the pre-processing liquid ejected from the head 20 in the pre-processing. The concentration of the pre-processing liquid is, for example, the concentration of a main component of the pre-processing liquid such as a polyvalent metal salt. The amount of the post-processing liquid is the total amount of the post-processing liquid ejected from the head 20 in the post-processing. The concentration of the post-processing liquid is, for example, the concentration of a main component of the post-processing liquid such as a resin. The fixing method in the pre-processing and the post-processing is, for example, a heat treatment method using a heat press plate, an oven, a hot air blower, or the like.

The printing information of the printing conditions is printing conditions that affect the color of an image printed according to the printing conditions. For example, the printing information of the printing conditions includes an ejection amount of the ink, printing resolution, the type of ink, whether or not a base is used, and an ejection amount of the base ink. In addition to the above, the printing information of the printing conditions includes a moving direction and a printing mode of the head 20 during the ejection operation in the printing operation, the humidity and the temperature in the printing apparatus 10, the type of illumination when the first image F printed on the printing medium A is viewed, and the type of the printing apparatus 10.

The ejection amount of the ink is the total amount of ink ejected from the head 20 when printing the first image F on the printing medium A based on the first image data. The printing resolution is the quotient obtained by dividing the printing region A1 of the printing medium A by the number of pixels. The first image F is formed of ink dots U for each pixel I. The larger the number of pixels, the larger the number of dots U forming the first image F, and therefore the larger the amount of ink that forms the first image F. The type of ink is the type of ink used for printing the first image F based on the first image data. For example, a basic color without a spot color, or a basic color and a spot color.

When acquiring the printing information, the controller 50 acquires a printing profile according to the printing information. The printing profile is a color conversion table and a conversion formula in which color values in a device-dependent color space and color values in a device-independent color space are associated with each other according to the printing information. The color values in the device-dependent color space are, for example, RGB values in the RGB color space. The color values in the device-independent color space are color values in a profile connection space (PCS). For example, Lab values in the L*a*b* color space and XYZ values in an XYZ color space. A Lab value represents one color by a combination of lightness L, and a and b representing hue and saturation.

Here, when the printing profile corresponding to the printing information is stored in the storage unit 53, the controller 50 acquires the printing profile from the storage unit 53. Further, when the printing profile corresponding to the printing information can be acquired from the external device D, the controller 50 acquires the printing profile from the external device D. Further, when the printing profile corresponding to the printing information cannot be acquired from the storage unit 53 and the external device D, the controller 50 acquires the printing profile based on colorimetric data of the colorimeter 16.

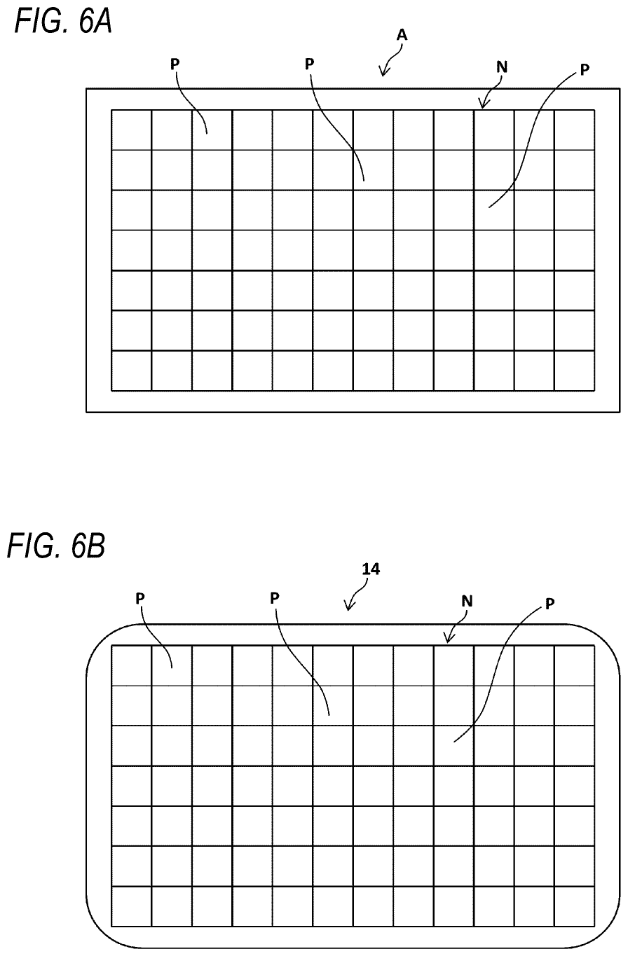

When the printing profile is acquired based on the colorimetric data of the colorimeter 16, the controller 50 acquires image data of a predetermined patch chart N as shown in the example of FIG. 6A from the storage unit 53. The patch chart N includes a plurality of patches P. The patch P is, for example, a rectangular color chart, and may have a size that allows the colorimeter 16 to measure the color, and may be determined in advance according to the resolution capability of the colorimeter 16. The plurality of patches P in the patch chart N have different color values from each other. The color values are, for example, color values that express the color gamut of the RGB color space in a predetermined gradation, for example, every 32 gradations. When the color values are expressed every 32 gradations, the patch chart N has patches P of 729 colors that are combinations of R, G, and B colors.

The controller 50 converts, for example, the RGB values of the patch chart N into color values printable by the head 20 based on a predetermined color conversion profile. The predetermined color conversion profile defines a correspondence relationship between the RGB value and the printable color value, and is stored in the storage unit 53. The printable color value is based on the color of the ink that can be ejected from the head 20. For example, in a case where the ink of basic colors can be ejected from the head 20, the color values include CMYK values, which are color coordinates in a device-dependent CMYK space. The CMYK values, for example, represent one color by combining a cyan color value, a magenta color value, a yellow color value, and a black color value of a predetermined gradation. In a case where the ink of the basic colors and the ink of the spot colors can be ejected from the head 20, the color value is expressed in color coordinates in the device-dependent CMYK and the color space of spot colors.

Then, the controller 50 prints the patch chart N on the printing medium A according to the printing information based on the image data of the patch chart N converted into the printable color values. For example, when it is desired to acquire a printing profile according to the type of the printing medium A, the patch chart N is printed on the printing medium A. When it is desired to acquire the printing profile according to the printing conditions, the patch chart N is printed on the printing medium A according to the printing conditions. Then, the controller 50 measures the color of each patch P of the patch chart N using the colorimeter 16, associates colorimetric values with the RGB values of each patch P, and stores them in the storage unit 53 as a printing profile. The colorimetric values are color values of a device-independent color space, for example, Lab values. In this way, the printing profile corresponding to the printing information is acquired.

Then, the controller 50 performs color conversion on the first image data based on the printing profile corresponding to the printing information, and generates second image data. Here, when there are a plurality of printing profiles, the controller 50 performs color conversion on the first image data based on the printing profiles and generates the second image data. As a result, the color values of the first image data, for example, the RGB values in the RGB color space which is the device-dependent color space, are converted into the color values of the second image data, for example, the Lab values in the L*a*b* color space which is the device-independent color space. The second image data is PCS image data.

Next, the controller 50 executes a second color conversion operation for generating third image data by performing color conversion on the second image data according to display conditions when the first image F is displayed on the display device 14 (step S3).

Specifically, the controller 50 acquires the display conditions from any one of the external device D, the storage unit 53, and the input device 15. The display conditions include, for example, display information of the display environment, display information of the display device 14, or display information of the display environment and the display device 14. The display information of the display environment is an element related to the display environment that affects the color of an image displayed on the display device 14. The display information of the display environment includes, for example, light emitted to an image displayed on the display device 14 or a type of the light source, such as sunlight, fluorescent light, and LED light.

The display information of the display device 14 is an element related to the display device 14 that affects the color of an image displayed on the display device 14. For example, the settings of the display device 14, including the color space and light source of the display device 14. The color space of the display device 14 defines the colors displayed on the display device 14 and is a device-dependent color space, examples of which include sRGB and adobeRGB. The light source is a light source used by the display device 14 to display an image, and examples of the light source include D50 and D65.

When acquiring the display information, the controller 50 acquires a display profile according to the display information. The display profile is a color conversion table and a conversion formula in which color values in a device-dependent color space and color values in a device-independent color space are associated with each other according to the display information. The color values in the device-dependent color space are, for example, RGB values in the RGB color space. The color values in the device-independent color space are the same as those in the device-independent color space of the printing profile, and are expressed, for example, as Lab values in the L*a*b* color space and XYZ values in an XYZ color space.

Here, when the display profile corresponding to the display information is stored in the storage unit 53, the controller 50 acquires the display profile from the storage unit 53. Further, when the display profile corresponding to the display information can be acquired from the external device D, the controller 50 acquires the display profile from the external device D. Further, when the display profile corresponding to the display information cannot be acquired from the storage unit 53 and the external device D, the controller 50 acquires the display profile based on colorimetric data of the colorimeter 16.

When the display profile is acquired based on the colorimetric data of the colorimeter 16, the controller 50 acquires image data of a predetermined patch chart N as shown in the example of FIG. 6B from the storage unit 53, and displays the patch chart N corresponding to the display information on the display device 14 based on the image data. Then, the controller 50 measures the color of each patch P of the patch chart N using the colorimeter 16, associates colorimetric values, for example, Lab values with the RGB values of each patch P, and stores them in the storage unit 53 as a display profile. In this way, the display profile corresponding to the display information is acquired.

Thus, the controller 50 performs color conversion on the second image data based on the display profile corresponding to the display information, and generates third image data. As a result, the color values of the second image data, for example, the Lab values in the L*a*b* color space which is the device-independent color space, are converted into the color values of the third image data, for example, the RGB values in the RGB color space which is the device-dependent color space.

Next, the controller 50 executes a display operation of displaying the second image H on the display device 14 based on the third image data (step S4). Since the third image data is obtained by performing the color conversion based on the first image data of the first image F according to the printing information and display information, the second image H based on the third image data takes into account factors that affect the colors of the printed image and the display image. Therefore, the accuracy of the simulation of the first image F printed on the printing medium A can be improved.

When the user views the simulation and prints the first image F, the controller 50 executes the printing operation (step S5). When the first image data is expressed in color values that can be printed by the printing apparatus 10, for example, a CMYK value, the controller 50 prints the first image F on the printing medium A based on the first image data. On the other hand, when the first image data is expressed in RGB values, the controller 50 converts the first image data into color values through which the first image data can be printed by the printing apparatus 10 based on a predetermined color conversion profile, generates printing data, and prints the first image F on the printing medium Abased on the printing data.

### Modification 1

The printing apparatus 10 according to Modification 1 is directed to Embodiment 1, in which the controller 50 performs color conversion such that the greater the ejection amount of the ink when printing the first image F based on the first image data, the darker the second image H displayed on the display device 14 will be in the first color conversion operation. Here, in the first color conversion operation, the controller 50 may vary any one of the hue, the lightness, the saturation, a combination of the hue and the lightness, a combination of the lightness and the saturation, a combination of the saturation and the hue, and a combination of the hue, the lightness and the saturation of the second image data as the ejection amount of the ink when printing the first image F based on the first image data increases. In this case, the controller 50 may vary a hue angle for the hue, vary the lightness such that it is lower, and vary the saturation such that it is farther away from the origin of the Lab color space.

Specifically, in the first color conversion operation in step S2 in FIG. 4, the controller 50 divides the first image F into a plurality of pixels I, that is, regions, in a matrix shape based on the first image data acquired in the first acquisition operation in step S1. Then, the controller 50 performs a color conversion process on the first image data to convert the RGB values into printable color values. Then, the controller 50 performs a halftone process on the data obtained by converting the first image data into printable color values, and acquires the size of the dots U in the first image F for each color and each pixel I. The size of the dot U corresponds to the ejection amount of the ink, such that the size becomes larger as the ejection amount of the ink increases. Therefore, the controller 50 acquires the ejection amount of the ink used for printing the first image F based on the first image data.

Then, the controller 50 acquires a printing profile corresponding to the ejection amount of the ink as a printing profile corresponding to the printing information. The printing profile corresponds RGB values and Lab values according to the ejection amount of the ink, and includes a color conversion table and conversion formula. The printing profile corresponding to the ejection amount of the ink is stored in the storage unit 53, with RGB values and Lab values corresponding to each other such that the greater the ejection amount of the ink, the darker the color of the second image H displayed on display device 14 becomes.

The printing profile corresponding to the ejection amount of the ink includes a plurality of printing profiles having different ejection amounts of the ink, for example, a first printing profile and a second printing profile. The first printing profile is a printing profile in which the ejection amount of the ink is a first ejection amount. The second printing profile is a printing profile in which the ejection amount of the ink is a second ejection amount which is greater than the first ejection amount.

When target colors that are the same among the colors of the first image data are subjected to color conversion using the second printing profile and the first printing profile, the second color, which is the color of the second image H when the color conversion is performed using the second printing profile, is darker than the first color, which is the color of the second image H when the color conversion is performed using the first printing profile. Therefore, when the same target colors among the colors of the first image data are subjected to color conversion using the second printing profile and the first printing profile, the second image data obtained when the color conversion is performed using the second printing profile and the second image data obtained when the color conversion is performed using the first printing profile are different in at least one of hue, saturation, and lightness.

That is, for example, the same target colors among the colors of the first image data are subjected to color conversion using the second printing profile and the first printing profile to generate the second image data. In this case, regarding the hue, the second image data obtained by performing the color conversion using the first printing profile and the second image data obtained by performing the color conversion using the second printing profile have the color coordinates of a hue angle where the second color is darker than the first color in the L*a*b* color space. In addition, regarding the saturation, color coordinates of the second image data obtained by performing the color conversion using the second printing profile are positioned farther from the origin, for example, zero, in the L*a*b* color space than color coordinates of the second image data obtained by performing the color conversion using the first printing profile.

In addition, regarding the lightness, the lightness of the second image data obtained by performing the color conversion using the second printing profile is lower than the lightness of the second image data obtained by performing the color conversion using the first printing profile. That is, when the lightness is a positive value, the second image data has color coordinates in the L*a*b* color space such that the lightness of the second image data obtained by performing the color conversion using the second printing profile is smaller than the lightness of the second image data obtained by performing the color conversion using the first printing profile. Further, when the lightness is a negative value, the second image data has color coordinates in the L*a*b* color space such that the lightness of the second image data obtained by performing the color conversion using the second printing profile is larger than the lightness of the second image data obtained by performing the color conversion using the first printing profile. In this way, the greater the ejection amount of the ink, the lower the lightness of the second image data, and the darker the second image H becomes.

Then, the controller 50 acquires the printing profile corresponding to the printing information, including the printing profile corresponding to the ejection amount of the ink from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4). Accordingly, compared with the density of the second image H when the ejection amount of the ink used to print the first image F is the first ejection amount, the density of the second image H is darker when the ejection amount of the ink is the second ejection amount, which is larger than the first ejection amount. In this way, the greater the ejection amount of the ink at time of printing the first image F, the color of the first image F printed on the printing medium A becomes darker, and the color of the second image H displayed on the display device 14 becomes darker. Therefore, the accuracy of the simulation of the first image F can be improved by using the second image H.

### Modification 2

The printing apparatus 10 according to Modification 2 is directed to Embodiment 1 and Modification 1, in which the controller 50 performs color conversion such that the higher the printing resolution when printing the first image F based on the first image data, the darker the second image H displayed on the display device 14 will be in the first color conversion operation. Here, in the first color conversion operation, the controller 50 may vary one of the hue, the lightness, the saturation, a combination of the hue and the lightness, a combination of the lightness and the saturation, a combination of the saturation and the hue, and a combination of the hue, the lightness and the saturation of the second image data, the higher the printing resolution when printing the first image F based on the first image data. In this case, the controller 50 may vary a hue angle for the hue, vary the lightness such that it is lower, and vary the saturation such that it is farther away from the origin of the Lab color space.

Specifically, in the first color conversion operation in step S2 in FIG. 4, the controller 50 divides the first image F into a plurality of pixels I, that is, regions, in a matrix shape based on the first image data acquired in the first acquisition operation in step S1. Here, the controller 50 acquires the density of the pixel I as the printing resolution. Then, the controller 50 acquires a printing profile corresponding to the printing resolution as a printing profile corresponding to the printing information. The printing profile corresponds RGB values and Lab values according to the printing resolution, and includes a color conversion table and conversion formula. The printing profile is stored in the storage unit 53, with RGB values and Lab values corresponding to each other such that the higher the printing resolution, the darker the second image H displayed on display device 14 becomes.

The printing profile corresponding to the printing resolution includes a plurality of printing profiles having different printing resolutions, for example, a third printing profile and a fourth printing profile. The third printing profile is a printing profile whose printing resolution is a first printing resolution. The fourth printing profile is a printing profile whose printing resolution is a second printing resolution, which is higher than the first printing resolution.

When target colors that are the same among the colors of the first image data are subjected to color conversion using the fourth printing profile and the third printing profile, the fourth color, which is the color of the second image H when the color conversion is performed using the fourth printing profile, is darker than the third color, which is the color of the second image H when the color conversion is performed using the third printing profile. Therefore, when the same target colors among the colors of the first image data are subjected to color conversion using the fourth printing profile and the third printing profile, the second image data obtained when the color conversion is performed using the fourth printing profile and the second image data obtained when the color conversion is performed using the third printing profile are different in at least one of hue, saturation, and lightness.

That is, for example, the same target colors among the colors of the first image data are subjected to color conversion using the fourth printing profile and the third printing profile to generate the second image data. In this case, regarding the hue, the second image data obtained by performing the color conversion using the third printing profile and the second image data obtained by performing the color conversion using the fourth printing profile have the color coordinates of a hue angle where the fourth color is darker than the third color in the L*a*b* color space. In addition, regarding the saturation, color coordinates of the second image data obtained by performing the color conversion using the fourth printing profile are positioned farther from the origin, for example, zero, in the L*a*b* color space than color coordinates of the second image data obtained by performing the color conversion using the third printing profile.

In addition, regarding the lightness, the lightness of the second image data obtained by performing the color conversion using the fourth printing profile is lower than the lightness of the second image data obtained by performing the color conversion using the third printing profile. That is, when the lightness is a positive value, the second image data has color coordinates in the L*a*b* color space such that the lightness of the second image data obtained by performing the color conversion using the fourth printing profile is smaller than the lightness of the second image data obtained by performing the color conversion using the third printing profile. Further, when the lightness is a negative value, the second image data has color coordinates in the L*a*b* color space such that the lightness of the second image data obtained by performing the color conversion using the fourth printing profile is larger than the lightness of the second image data obtained by performing the color conversion using the third printing profile. In this way, the higher the printing resolution, the lower the lightness of the second image data, and the darker the second image H becomes.

Then, the controller 50 acquires the printing profile corresponding to the printing information, including the printing profile corresponding to the printing resolution from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4).

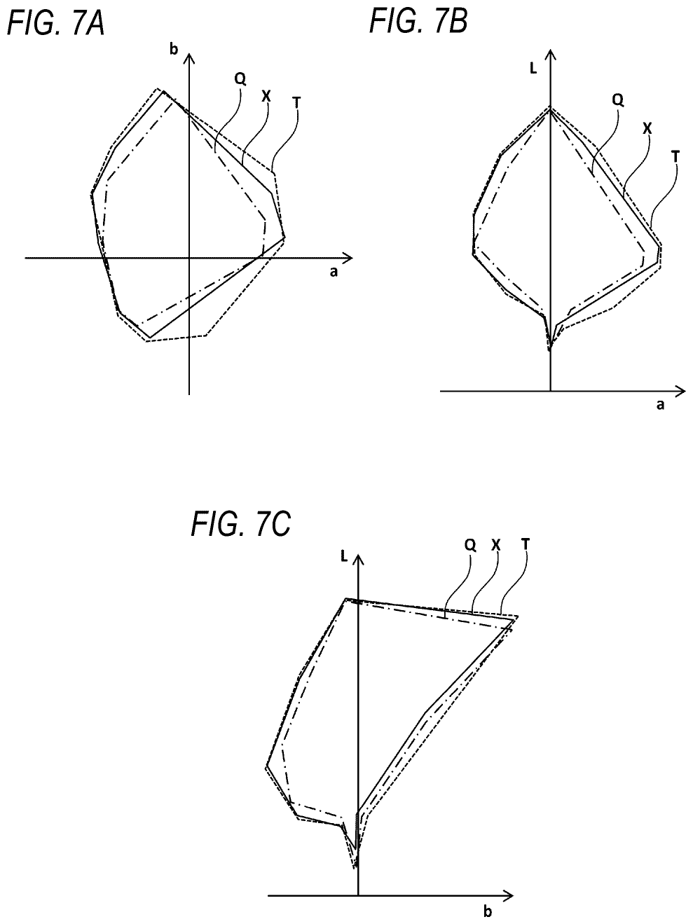

Accordingly, compared with the density of the second image H when the first image F has the first printing resolution, the density of the second image H when the first image F has the second printing resolution, which is higher than the first printing resolution. For example, as shown in the examples of FIG. 7A to FIG. 7C, a color value X of the first image F with a printing resolution of 1200 dpi has relatively larger values for the a-value and the b-value than a color value Q of the first image F with a printing resolution of 600 dpi. In this way, the higher the printing resolution when printing the first image F, the greater the number of dots U required to print the first image F, and therefore, the color of the first image F printed on the printing medium A becomes darker, and the color of the second image H displayed on the display device 14 becomes darker. Therefore, the accuracy of the simulation of the first image F can be improved by using the second image H.

### Modification 3

The printing apparatus 10 according to Modification 3 is directed to Embodiment 1 and Modifications 1 and 2, in which the controller 50 performs color conversion such that the more types of ink are used when printing the first image F based on the first image data, the higher the saturation of the second image data in the first color conversion operation.

Specifically, in the first color conversion operation in step S2 in FIG. 4, the controller 50 divides the first image F into a plurality of pixels I, that is, regions, in a matrix shape based on the first image data acquired in the first acquisition operation in step S1. Then, the controller 50 performs a color conversion process on the first image data to convert the RGB values that define the colors of the first image data into printable color values for each pixel I. Examples of the printable color values include CMYK values and color coordinates in CMYK and the color space of spot colors. The controller 50 counts the type of ink used for printing the first image F based on the printable color value, and acquires the number of types of ink.

Then, the controller 50 acquires a printing profile corresponding to the number of types of ink as a printing profile corresponding to the printing information. The printing profile corresponds RGB values and Lab values according to the number of types of ink, and includes a color conversion table and conversion formula. The printing profile corresponding to the number of types of ink is stored in the storage unit 53, with RGB values and Lab values corresponding to each other such that the greater the number of types of ink, the higher the saturation of the second image H displayed on display device 14.

The printing profile corresponding to the number of types of ink includes a plurality of printing profiles having different numbers of types of ink, for example, a fifth printing profile and a sixth printing profile. The fifth printing profile is a printing profile in which the number of types of ink is a first number. The sixth printing profile is a printing profile in which the number of types of ink is a second number, which is greater than the first number.

When target colors that are the same among the colors of the first image data are subjected to color conversion using the sixth printing profile and the fifth printing profile, the sixth color, which is the color of the second image H when the color conversion is performed using the sixth printing profile, is more saturated and vivid than the fifth color, which is the color of the second image H when the color conversion is performed using the fifth printing profile. Therefore, when the same target colors among the colors of the first image data are subjected to color conversion using the sixth printing profile and the fifth printing profile, the saturation of the second image data obtained when the color conversion is performed using the sixth printing profile is higher than the saturation of the second image data obtained when the color conversion is performed using the fifth printing profile. That is, color coordinates of the second image data obtained by performing the color conversion using the sixth printing profile are positioned farther from the origin, for example, zero, in the L*a*b* color space than color coordinates of the second image data obtained by performing the color conversion using the fifth printing profile.

Then, the controller 50 acquires the printing profile corresponding to the printing information, including the printing profile corresponding to the number of types of ink from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4). Accordingly, compared with the saturation of the second image H when the number of types of ink used to print the first image F is the first number, the saturation of the second image H is higher when the number of types of ink is the second number, which is larger than the first number. In this way, the greater the number of types of ink used at time of printing the first image F, the color of the first image F printed on the printing medium A becomes vivid, and the color of the second image H displayed on the display device 14 becomes vivid. Therefore, the accuracy of the simulation of the first image F can be improved by using the second image H.

### Modification 4

The printing apparatus 10 according to Modification 4 is directed to Embodiment 1 and Modifications 1 to 3, in which the controller 50 performs the color conversion in the first color conversion operation such that when the types of ink to be used for printing the first image F based on the first image data are predetermined basic colors and chromatic colors other than the basic colors, the saturation of the second image data is higher than when the ink types are only basic colors.

Specifically, in the first color conversion operation in step S2 in FIG. 4, the controller 50 divides the first image F into a plurality of pixels I, that is, regions, in a matrix shape based on the first image data acquired in the first acquisition operation in step S1. Then, the controller 50 performs a color conversion process on the first image data to convert the RGB values that define the colors of the first image data into printable color values such as a CMYK value for each pixel I. The controller 50 determines, based on the printable color value, whether the types of ink used for printing the first image F include a spot color, which is a chromatic color other than the basic colors.

Then, the controller 50 acquires a printing profile corresponding to the type of ink as a printing profile corresponding to the printing information. The printing profile corresponds RGB values and Lab values according to the type of ink, and includes a color conversion table and conversion formula. The printing profile corresponding to the type of ink is stored in the storage unit 53, with RGB values and Lab values corresponding to each other such that the saturation of the second image H displayed on the display device 14 is higher when the type of ink includes a spot color than when the type of ink does not include a spot color.

The printing profile corresponding to the type of ink includes a plurality of printing profiles having different types of ink, for example, a seventh printing profile and an eighth printing profile. The seventh printing profile is a printing profile when the type of ink does not include a spot color. The eighth printing profile is a printing profile when the type of ink includes a spot color.

When target colors that are the same among the colors of the first image data are subjected to color conversion using the eighth printing profile and the seventh printing profile, the eighth color, which is the color of the second image H when the color conversion is performed using the eighth printing profile, is more saturated and vivid than the seventh color, which is the color of the second image H when the color conversion is performed using the seventh printing profile. Therefore, when the same target colors among the colors of the first image data are subjected to color conversion using the eighth printing profile and the seventh printing profile, the saturation of the second image data obtained when the color conversion is performed using the eighth printing profile is higher than the saturation of the second image data obtained when the color conversion is performed using the seventh printing profile. That is, color coordinates of the second image data obtained by performing the color conversion using the eighth printing profile are positioned farther from the origin, for example, zero, in the L*a*b* color space than color coordinates of the second image data obtained by performing the color conversion using the seventh printing profile.

Then, the controller 50 acquires the printing profile corresponding to the printing information, including the printing profile corresponding to the types of ink from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4).

Thus, the saturation of the second image H when the first image F is printed using ink that includes a spot color is higher than the saturation of the second image H when the first image F is printed using ink that does not include a spot color. As shown in the examples of FIG. 7A to FIG. 7C, the color value T of the first image F printed with inks of chromatic red and violet and basic color shows larger values for the a-value and b-value than the color value X of the first image F printed with inks of basic colors without including chromatic spot colors. In this way, as compared with the case of not including a spot color, when the ink used to print the first image F includes a spot color, the color of the first image F printed on the printing medium A becomes vivid, and the color of the second image H displayed on the display device 14 becomes vivid. Therefore, the accuracy of the simulation of the first image F can be improved by using the second image H.

### Modification 5

The printing apparatus 10 according to Modification 5 is directed to Embodiment 1 and Modifications 1 to 4, in which the controller 50 performs the color conversion in the first color conversion operation such that in a case where the first image F is printed based on the first image data on a base formed by ejecting the base ink onto a surface of the printing medium A, the second image H displayed on the display device 14 becomes darker than when the first image F is printed on the surface of the printing medium A without the base based on the first image data. Here, in the first color conversion operation, when the first image F is printed based on the first image data on a base formed by ejecting the base ink onto a surface of the printing medium A, the controller 50 may vary one of the hue, the lightness, the saturation, a combination of the hue and the lightness, a combination of the lightness and the saturation, a combination of the saturation and the hue, and a combination of the hue, the lightness and the saturation of the second image data from a case where the first image F is printed on the surface of the printing medium A without the base based on the first image data. In this case, the controller 50 may vary a hue angle for the hue, vary the lightness such that it is lower, and vary the saturation such that it is farther away from the origin of the Lab color space.

Specifically, the controller 50 acquires the printing information of the printing condition in the first color conversion operation in step S2 of FIG. 4. The printing information of the printing condition includes the presence or absence of a base printed on the surface of the printing medium A before the first image F is printed. The printing information may be input to the controller 50 from the input device 15 by the user, or may be input from the external device D and the storage unit 53 to the controller 50.

Then, the controller 50 acquires the printing profile for base as the printing profile corresponding to the printing information when the printing information indicates that there is a base, and acquires the printing profile for no base as the printing profile corresponding to the printing information when the printing information indicates that there is no base. The printing profile corresponds RGB values and Lab values according to the presence or absence of a base, and includes a color conversion table and conversion formula. The printing profile according to the base is stored in the storage unit 53, with RGB values and Lab values corresponding to each other such that the second image H displayed on the display device 14 is darker when there is a base than when there is no base.

When target colors that are the same among the colors of the first image data are subjected to color conversion using the tenth printing profile and the ninth printing profile, the tenth color, which is the color of the second image H when the color conversion is performed using the tenth printing profile, is darker than the ninth color, which is the color of the second image H when the color conversion is performed using the ninth printing profile. Therefore, when the same target colors among the colors of the first image data are subjected to color conversion using the tenth printing profile and the ninth printing profile, the second image data obtained when the color conversion is performed using the tenth printing profile and the second image data obtained when the color conversion is performed using the ninth printing profile are different in at least one of hue, saturation, and lightness.

That is, for example, the same target colors among the colors of the first image data are subjected to color conversion using the tenth printing profile and the ninth printing profile to generate the second image data. In this case, regarding the hue, the second image data obtained by performing the color conversion using the ninth printing profile and the second image data obtained by performing the color conversion using the tenth printing profile have the color coordinates of a hue angle where the tenth color is darker than the ninth color in the L*a*b* color space. In addition, regarding the saturation, color coordinates of the second image data obtained by performing the color conversion using the tenth printing profile are positioned farther from the origin, for example, zero, in the L*a*b* color space than color coordinates of the second image data obtained by performing the color conversion using the ninth printing profile.

In addition, regarding the lightness, the lightness of the second image data obtained by performing the color conversion using the tenth printing profile is lower than the lightness of the second image data obtained by performing the color conversion using the ninth printing profile. That is, when the lightness is a positive value, the second image data has color coordinates in the L*a*b* color space such that the lightness of the second image data obtained by performing the color conversion using the tenth printing profile is smaller than the lightness of the second image data obtained by performing the color conversion using the ninth printing profile. Further, when the lightness is a negative value, the second image data has color coordinates in the L*a*b* color space such that the lightness of the second image data obtained by performing the color conversion using the tenth printing profile is larger than the lightness of the second image data obtained by performing the color conversion using the ninth printing profile. In this way, the lightness of the second image data when there is a base is lower than the lightness of the second image data when there is no base, and the lightness of the second image H when there is a base is darker than the lightness of the second image H when there is no base.

The controller 50 acquires the printing profile corresponding to the printing information, including the printing profile for base and the printing profile for no base from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4).

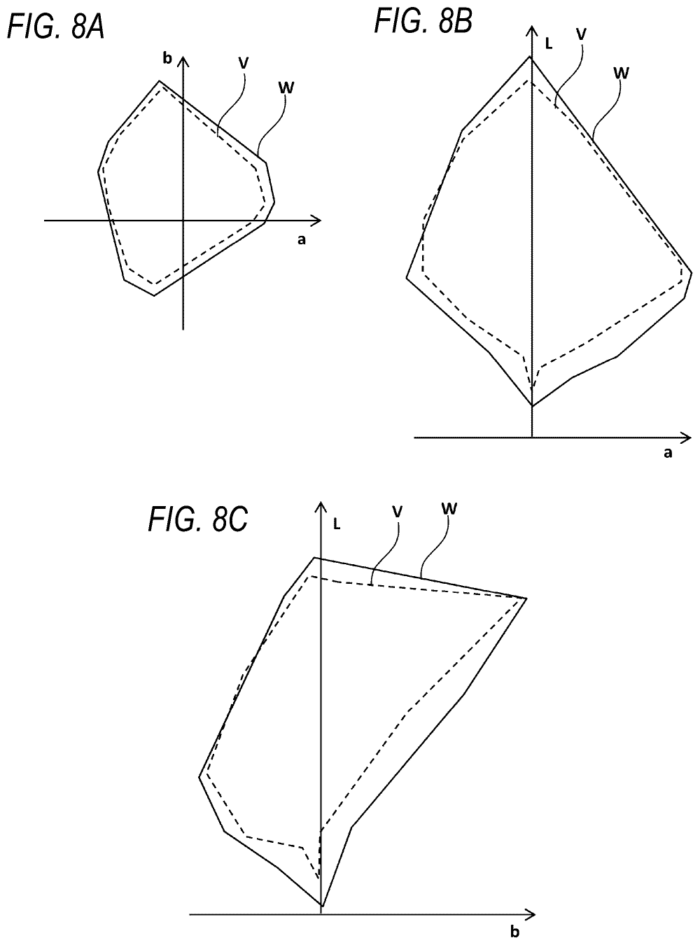

Accordingly, the density of the second image H is darker in the case where the base is present than in the case where the base is absent in the first image F. As shown in the examples of FIG. 8A to FIG. 8C, a color value W of the first image F in a case where the base is present has larger values for the a-value and the b-value than a color value V of the first image F in a case where the base is absent. In this way, the color of the first image F printed on the printing medium A becomes darker, and the color of the second image H displayed on the display device 14 becomes darker in a case where the first image F is printed with a base than with no base. Therefore, the accuracy of the simulation of the first image F can be improved by using the second image H.

### Modification 6

The printing apparatus 10 according to Modification 6 is directed to Embodiment 1 and Modifications 1 to 5, in which the controller 50 performs the color conversion in the first color conversion operation such that in a case where the first image F is printed based on the first image data on a base formed by ejecting the base ink onto a surface of the printing medium A, the greater the ejection amount of the base ink, the darker the second image H displayed on the display device 14. Here, in the first color conversion operation, in a case where the first image F is printed based on the first image data on a base formed by ejecting the base ink onto a surface of the printing medium A, the controller 50 may vary any one of the hue, the lightness, the saturation, a combination of the hue and the lightness, a combination of the lightness and the saturation, a combination of the saturation and the hue, and a combination of the hue, the lightness and the saturation of the second image data as the ejection amount of the base ink increases. In this case, the controller 50 may vary a hue angle for the hue, vary the lightness such that it approaches a negative value or becomes more negative, and vary the saturation such that it approaches the origin of the Lab color space.

Specifically, the controller 50 acquires the ejection amount of the base ink as the printing information of the printing condition in the first color conversion operation in step S2 of FIG. 4. The ejection amount of the base ink is acquired based on, for example, a base size and the printing resolution. The base size may be a size of a base to be printed with the base ink on the surface of the printing medium A before printing the first image F, may be input to the controller 50 by the user through the input device 15, or may be input to the controller 50 from the external device D and the storage unit 53. The base size may be a predetermined range such as the same region as the printing region A1, and may be stored in the storage unit 53 in advance. Alternatively, the base size may be acquired by the controller 50 based on the first image data of the first image F, as a range in which an outer edge of the base is the same as an outer edge of the first image F or surrounds the outer edge of the first image F, so that the first image F is printed on the base. The printing information may include the presence or absence of a base.

Then, the controller 50 acquires the ejection amount of the base ink such that the larger the base size, the greater the ejection amount of the base ink. Further, the controller 50 acquires the ejection amount of the base ink such that the higher the printing resolution, the greater the ejection amount of the base ink. In this manner, the controller 50 acquires the ejection amount of the base ink in the case of printing the first image F based on the base size and the printing resolution, and acquires the printing profile corresponding to the ejection amount of the base ink. The printing profile corresponds RGB values and Lab values according to the ejection amount of the base ink, and includes a color conversion table and conversion formula. The printing profile corresponding to the ejection amount of the base ink is stored in the storage unit 53, with RGB values and Lab values corresponding to each other such that the greater the ejection amount of the base ink, the darker the color of the second image H displayed on display device 14 becomes.

The printing profile corresponding to the ejection amount of the base ink includes a plurality of printing profiles having different ejection amounts of the base ink, for example, an eleventh printing profile and a twelfth printing profile. The eleventh printing profile is a printing profile in which the ejection amount of the base ink is a third ejection amount. The twelfth printing profile is a printing profile in which the ejection amount of the base ink is a fourth ejection amount which is greater than the third ejection amount.

When target colors that are the same among the colors of the first image data are subjected to color conversion using the twelfth printing profile and the eleventh printing profile, the twelfth color, which is the color of the second image H when the color conversion is performed using the twelfth printing profile, is darker than the eleventh color, which is the color of the second image H when the color conversion is performed using the eleventh printing profile. Therefore, when the same target colors among the colors of the first image data are subjected to color conversion using the twelfth printing profile and the eleventh printing profile, the second image data obtained when the color conversion is performed using the twelfth printing profile and the second image data obtained when the color conversion is performed using the eleventh printing profile are different in at least one of hue, saturation, and lightness.

That is, for example, the same target colors among the colors of the first image data are subjected to color conversion using the twelfth printing profile and the eleventh printing profile to generate the second image data. In this case, regarding the hue, the second image data obtained by performing the color conversion using the eleventh printing profile and the second image data obtained by performing the color conversion using the twelfth printing profile have the color coordinates of a hue angle where the twelfth color is darker than the eleventh color in the L*a*b* color space. In addition, regarding the saturation, color coordinates of the second image data obtained by performing the color conversion using the twelfth printing profile are positioned farther from the origin, for example, zero, in the L*a*b* color space than color coordinates of the second image data obtained by performing the color conversion using the eleventh printing profile.

In addition, regarding the lightness, the lightness of the second image data obtained by performing the color conversion using the twelfth printing profile is lower than the lightness of the second image data obtained by performing the color conversion using the eleventh printing profile. That is, when the lightness is a positive value, the second image data has color coordinates in the L*a*b* color space such that the lightness of the second image data obtained by performing the color conversion using the twelfth printing profile is smaller than the lightness of the second image data obtained by performing the color conversion using the eleventh printing profile. Further, when the lightness is a negative value, the second image data has color coordinates in the L*a*b* color space such that the lightness of the second image data obtained by performing the color conversion using the twelfth printing profile is larger than the lightness of the second image data obtained by performing the color conversion using the eleventh printing profile. In this way, the greater the ejection amount of the base ink, the lower the lightness of the second image data, and the darker the second image H becomes.

Then, the controller 50 acquires the printing profile corresponding to the printing information, including the printing profile corresponding to the ejection amount of the base ink from the storage unit 53 or the external device D, or acquires the printing profile based on the colorimetric data of the colorimeter 16. Then, the controller 50 performs color conversion on the first image data based on the printing profile corresponding to the printing information, and generates second image data. Then, the controller 50 generates the third image data from the second image data by the second color conversion operation (step S3), and causes the display device 14 to display the second image H based on the third image data by the display operation (step S4). Accordingly, compared with the density of the second image H when the ejection amount of the base ink is the third ejection amount, the density of the second image H is darker when the ejection amount of the base ink is the fourth ejection amount, which is larger than the third ejection amount. In this way, the greater the ejection amount of the base ink at time of printing the first image F, the color of the first image F printed on the printing medium A becomes darker, and the color of the second image H displayed on the display device 14 becomes darker. Therefore, the accuracy of the simulation of the first image F can be improved by using the second image H.

### Modification 7

The printing apparatus 10 according to Modification 7 is directed to Embodiment 1 and Modification 1 to 6, the controller 50 executes a second acquisition operation of acquiring a color gamut that can be printed on the printing medium A by the ink ejected from the nozzle 24, and for pixels I that are outside the color gamut after the first image data is color converted in the first color conversion operation, the controller 50 assigns a special color value indicating that the pixels are outside the color gamut in the second color conversion operation, and generates the second image data.

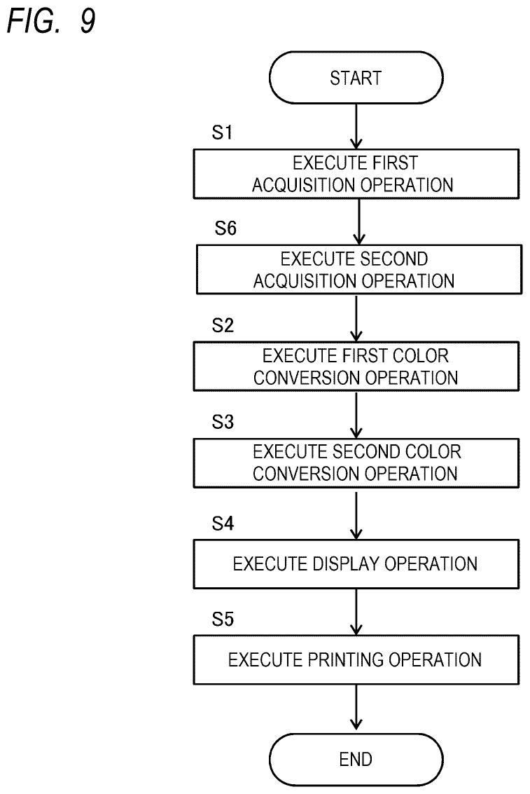

Specifically, a control method for the printing apparatus 10 is executed by the controller 50 according to a flowchart of FIG. 9, which shows an example of the control method. In the flowchart of FIG. 9, the controller 50 causes the second acquisition operation in step S6 to be executed between step S1 and step S2 in FIG. 4. In the second acquisition operation, the controller 50 acquires color values that can be printed with all inks provided in the printing apparatus 10, for example, CMYK values. The color values may be input to the controller 50 from the input device 15 or the external device D. When the color values are stored in advance in the storage unit 53, the controller 50 may acquire the color values from the storage unit 53.

Then, the controller 50 converts the CMYK values of the printable color values into Lab values based on a predetermined correspondence relationship between the CMYK values and the Lab values. The controller 50 renders the Lab value of the printable color value in the L*a*b* color space. The controller 50 acquires, as the print color gamut, a region occupied by Lab values of printable color values in the L*a*b* color space. The print color gamut is a region including all color values that can be printed in a predetermined color space, for example, the L*a*b* color space, and is a closed region in the L*a*b* color space.

Next, in the first color conversion operation in step S2, the controller 50 acquires a printing profile corresponding to the printing information, performs the color conversion on the first image data based on the printing profile, and generates the second image data. Accordingly, the color value for each pixel I in the first image F is acquired as the Lab value of the second image data. Then, the controller 50 renders the image color values, which are the Lab values of the second image data, in the L*a*b* color space. The controller 50 acquire, from among the image color values, image color values that are not included in the print color gamut as the color values of pixels I that are outside the print color gamut.

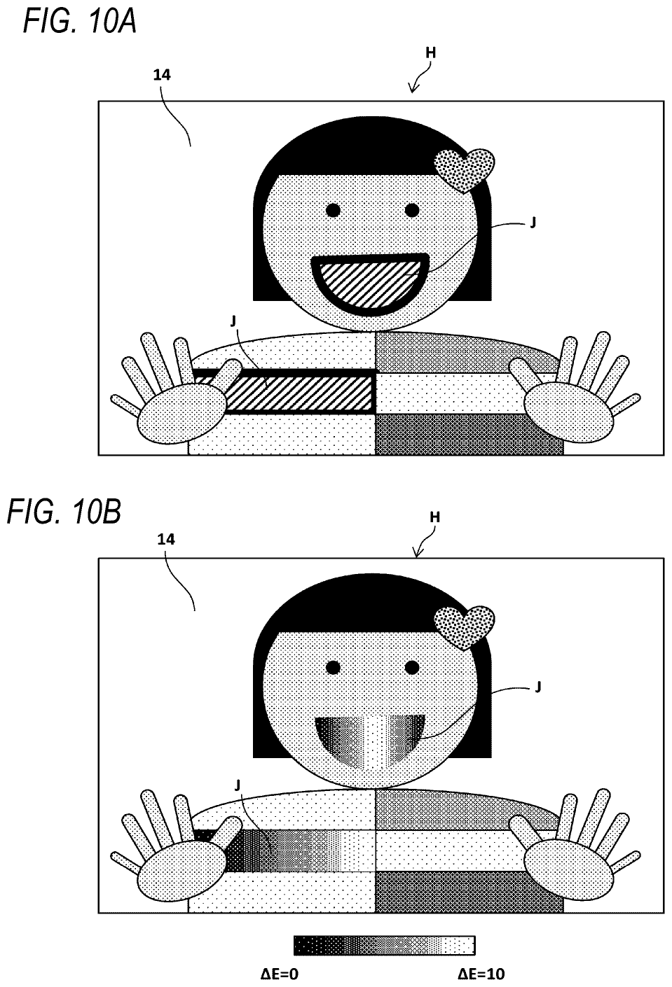

Next, in the second color conversion operation in step S3, the controller 50 acquires a display profile corresponding to the display information, performs color conversion on the second image data based on the display profile corresponding to the display information, and generates third image data. Here, the controller 50 assigns a special color value to the color value of the pixel I outside the print color gamut. The special color value is a color value indicating that the pixel is outside the print color gamut, and is, for example, a color value different from the image color value of the pixel I. In the example of FIG. 10A, the image color value of the pixel I in a portion J of the second image H is outside the print color gamut. In this case, the image color values are changed to be different from the image color values of the portion J in the third image data, for example by displaying the portion with diagonal lines of white and blue.

In the example of FIG. 10B, the controller 50 acquires the image color value of the pixel I in the portion J of the second image H and a color difference AE of the print color gamut. For example, the color difference AE is the length of a perpendicular line drawn from the image color value to the print color gamut in the L*a*b* color space. Alternatively, the color difference AE is the shortest length among lengths between the image color value and the print color gamut in the L*a*b* color space. Then, the controller 50 changes one of the hue, the lightness, and the saturation according to the color difference AE. For example, the controller 50 changes the image color value of the portion J in the third image data so that the lightness becomes higher and approaches white as the color difference AE becomes larger.

Next, the controller 50 causes the display device 14 to display the second image H based on the third image data by the display operation in step S4. The third image data is obtained by performing the color conversion based on the first image data of the first image F according to the printing information and display information, thereby improving the accuracy of the simulation of the first image F printed on the printing medium A or pixels I within the print color gamut of the second image H. Further, the pixel I outside the print color gamut is changed to a special color value. Since the pixel I outside the print color gamut is changed to a special color value, the pixel I outside the print color gamut in the second image H is displayed separately from the other parts. Therefore, the user can easily recognize that the pixel I is not included in the print color gamut by looking at this display.

### Embodiment 2

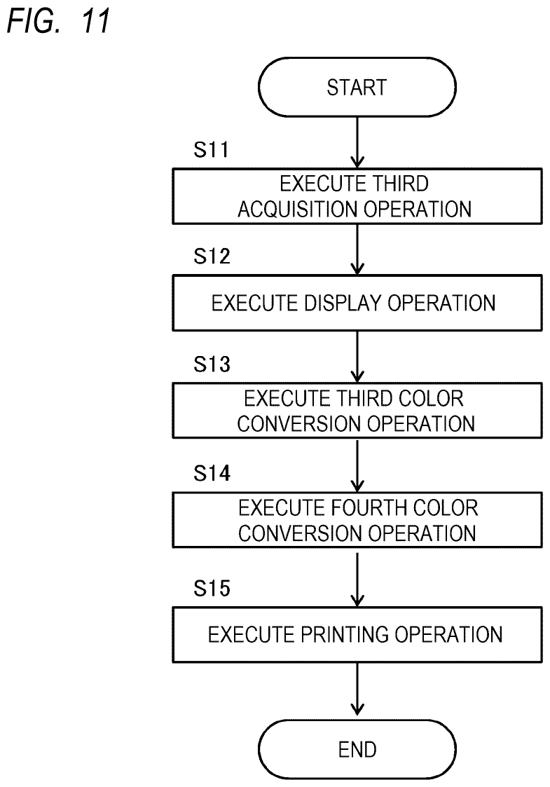

The printing apparatus 10 according to Embodiment 2 of the present disclosure is controlled by the controller 50, for example, according to a flowchart showing an example of the control method of FIG. 11. Here, when receiving a print job, the controller 50 executes each process according to the flowchart. The controller 50 executes a third acquisition operation to acquire fourth image data for displaying a third image on the display device 14 (step S11). The fourth image data is input data input to the controller 50 and is expressed by color values in a predetermined color space. The color values correspond to pixels I, which are a plurality of regions obtained by dividing the third image displayed on the display device 14 into unit areas. The color values are expressed, for example, as color coordinates in a device-dependent color space, such as RGB values in an RGB color space. Next, the controller 50 executes a display operation of displaying the third image on the display device 14 based on the fourth image data (step S12).

Next, the controller 50 executes a third color conversion operation for generating fifth image data by performing color conversion on the fourth image data according to display conditions when the third image is displayed on the display device 14 (step S13). Here, the controller 50 acquires a display profile corresponding to the display information of the display condition, performs color conversion on the fourth image data based on the display profile, and generates the fifth image data. As a result, the color values of the fourth image data, for example, the RGB values in the RGB color space which is the device-dependent color space, are converted into the color values of the fifth image data, for example, the Lab values in the L*a*b* color space which is the device-independent color space. The fifth image data is PCS image data.

Next, the controller 50 executes a fourth color conversion operation for generating sixth image data by performing color conversion on the fifth image data according to any one of the printing medium A, the printing condition, and a combination of the printing medium A and the printing condition when printing the third image on the printing medium A (step S14). Here, the controller 50 acquires a printing profile corresponding to at least one of the printing information of the printing medium A and the printing condition. Then, the controller 50 performs color conversion on the fifth image data based on the printing profile to generate the sixth image data. As a result, the color values of the fifth image data, for example, the Lab values in the L*a*b* color space which is the device-independent color space, are converted into the color values of the sixth image data, for example, the RGB values in the RGB color space which is the device-dependent color space or the CMYK values in the CMYK space. When the sixth image data is in RGB values, the controller 50 converts the RGB values into CMYK values based on a predetermined color conversion profile.

Next, the controller 50 executes a printing operation to print a fourth image on the printing medium Abased on the sixth image data (step S15). Since the sixth image data is obtained by performing the color conversion based on the fourth image data of the third image according to the printing information and display information, the sixth image data takes into account factors that affect the colors of the printed image and the display image. Therefore, the fourth image can be printed on the printing medium A in colors approximating the third image displayed on the display device 14.

### Modification 8

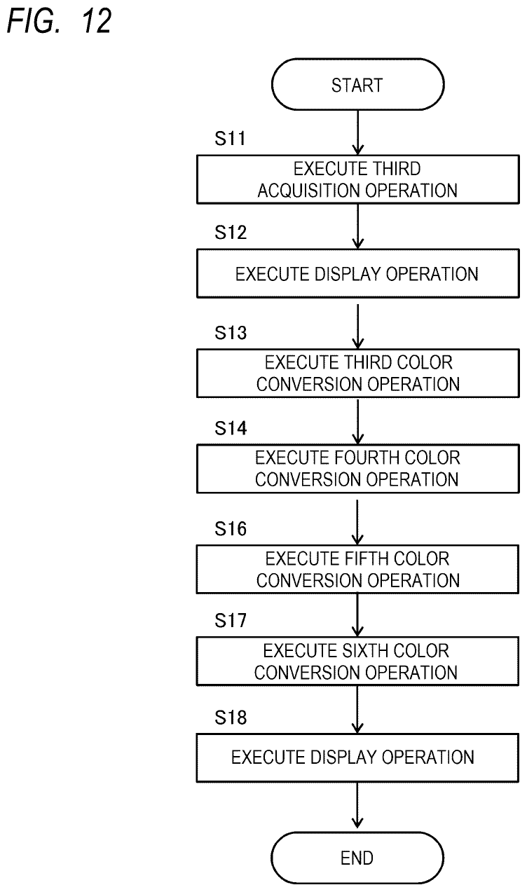

The printing apparatus 10 according to Modification 8 is directed to Embodiment 2, and is controlled by the controller 50, for example, according to a flowchart showing an example of the control method of FIG. 12. In the flowchart of FIG. 12, the controller 50 executes a fifth color conversion operation in step S16, a sixth color conversion operation in step S17, and a display operation in step S18, instead of step S15 in FIG. 11.

Specifically, for example, due to differences between the display color gamut of the display device 14 and the print color gamut of the printing apparatus 10, the fourth image may be printed in colors that are not close to the colors of the third image displayed on the display device 14 in step S12. Therefore, the controller 50 executes the operations in steps S16 to S18 to simulate how the fourth image will be printed.

When simulating how the fourth image will be printed, the controller 50 performs the fifth color conversion operation for generating seventh image data by performing color conversion on the sixth image data according to the display conditions when the fourth image, which is to be printed on the printing medium A based on the sixth image data using ink ejected from the nozzles 24, is displayed on the display device 14 (step S16). Here, the controller 50 acquires a display profile corresponding to the display information of the display condition, performs color conversion on the sixth image data based on the display profile, and generates the seventh image data. As a result, the color values of the sixth image data, for example, the RGB values in the RGB color space which is the device-dependent color space, are converted into the color values of the seventh image data, for example, the Lab values in the L*a*b* color space which is the device-independent color space. The seventh image data is PCS image data.

Next, the controller 50 executes the sixth color conversion operation for generating eighth image data by performing color conversion on the seventh image data according to any one of the printing medium A, the printing condition, and a combination of the printing medium A and the printing condition when printing the fourth image on the printing medium A (step S17). Here, the controller 50 acquires a printing profile corresponding to at least one of the printing information of the printing medium A and the printing condition. Then, the controller 50 performs color conversion on the seventh image data based on the printing profile to generate the eighth image data. As a result, the color values of the seventh image data, for example, the Lab values in the L*a*b* color space which is the device-independent color space, are converted into the color values of the eighth image data, for example, the RGB values in the RGB color space which is the device-dependent color space or the CMYK values in the CMYK space. When the eighth image data is in RGB values, the controller 50 converts the RGB values into CMYK values based on a predetermined color conversion profile.

Next, the controller 50 executes a display operation of displaying a fifth image on the display device 14 based on the eighth image data (step S18). Since the eighth image data is obtained by performing the color conversion based on the sixth image data of the fourth image to be printed on the printing medium A according to the printing information and display information, the fourth image to be displayed on the display device 14 based on the eighth image data takes into account factors that affect the colors of the printed image and the display image. Therefore, the accuracy of the simulation of the fourth image to be printed on the printing medium A can be improved.

### Embodiment 3

A printing system 60 according to Embodiment 3 of the present disclosure includes an image processing apparatus 61 and a printing apparatus 62 including the nozzle 24 for ejecting ink. The image processing apparatus 61 includes the display device 14 and the controller 50. The controller 50 executes the first acquisition operation of acquiring the first image data for printing the first image F on the printing medium A using the ink ejected from the nozzle 24, the first color conversion operation of performing color conversion on the first image data to generate the second image data, the second color conversion operation of performing color conversion on the second image data according to a display condition when the first image F is displayed on the display device 14 so as to generate the third image data, the display operation of displaying the second image H on the display device 14 based on the third image data, and a printing data generation operation of generating printing data corresponding to the color gamut of the printing apparatus 10 based on the first image data. The printing apparatus 62 executes the printing operation of printing the first image F on the printing medium A based on the printing data. The first color conversion operation performs color conversion according to any one of the printing medium A, printing conditions, and a combination of the printing medium A and the printing conditions.

Specifically, in Embodiment 1, the printing apparatus 10 includes the nozzle 24, the display device 14, and the controller 50. In this regard, in Embodiment 3, the printing system 60 is configured such that the printing apparatus 10 includes the nozzle 24, and the image processing apparatus 61 includes the display device 14 and the controller 50. Since the printing system 60 according to Embodiment 3 includes the nozzle 24, the display device 14, and the controller 50 similarly to the printing apparatus 10 according to Embodiment 1, the controller 50 of the printing system 60 can execute the first color conversion operation in Modifications 1 to 7.

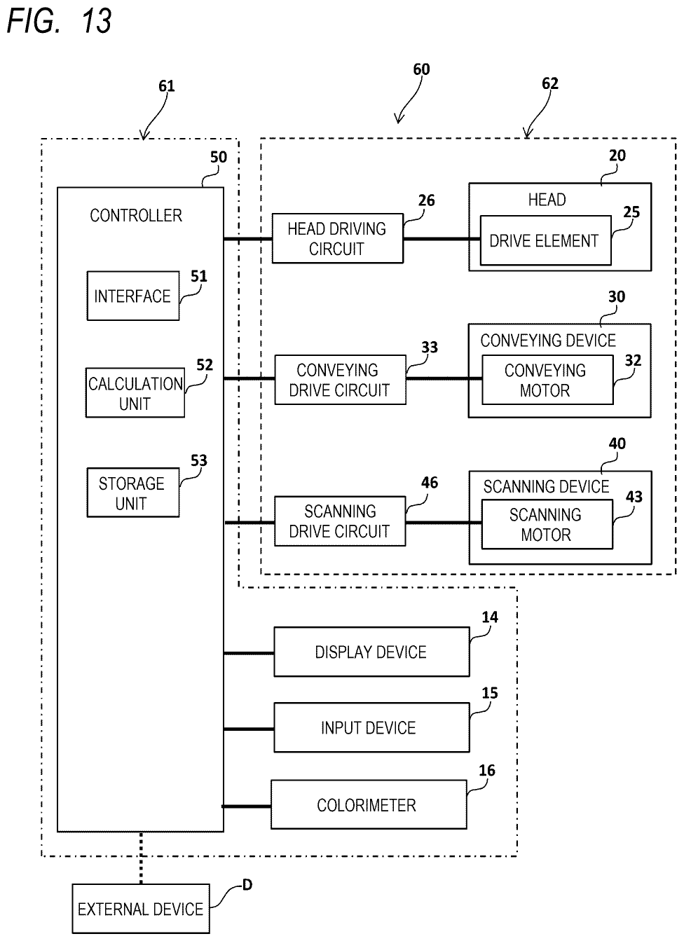

As shown in FIG. 13, the image processing apparatus 61 of the printing system 60 is, for example, a computer, and includes the input device 15 and the colorimeter 16 in addition to the display device 14 and the controller 50. The input device 15 and the colorimeter 16 may be included in the printing apparatus 10, or may be provided in the printing system 60 separately from the image processing apparatus 61 and the printing apparatus 10. The printing apparatus 62 of the printing system 60 is connected to the controller 50 of the image processing apparatus 61 and is controlled by the controller 50. In addition to the image processing apparatus 61, the controller 50 may also be provided in the printing apparatus 10, and these may cooperate to perform the operation of the controller 50.

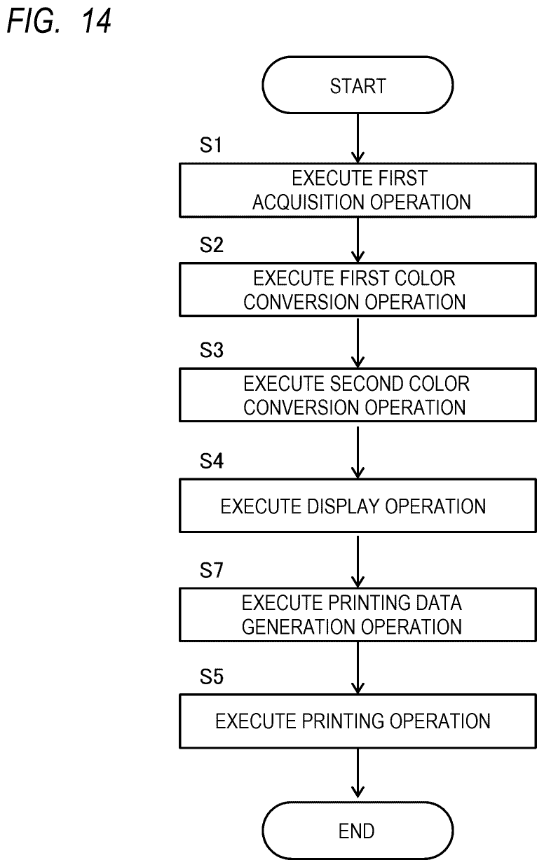

A control method for the printing system 60 is executed by the controller 50 according to a flowchart of FIG. 14, which shows an example of the control method. In the flowchart of FIG. 14, the controller 50 executes the printing data generation operation in step S7 after step S4 in FIG. 4. In the printing data generation operation in step S7, the controller 50 acquires, from the storage unit 53 or the external device D, a predetermined color conversion profile in which a print color gamut that is a color gamut that can be printed by the printing apparatus 10 is associated with a color value of the first image data, for example, an RGB value. The print color gamut includes all color values that can be printed using the inks provided in the printing apparatus 10, and examples of the color values include CMYK values, and color coordinates in the color space of CMYK and spot colors. Then, the controller 50 performs color conversion based on the predetermined color conversion profile to generate the printing data.

Then, in the printing operation of step S5, the printing apparatus 62 acquires the printing data from the controller 50, and prints the first image F on the printing medium A based on the printing data. According to such a printing system 60, the second image H displayed on the display device 14 based on the third image data in the display operation of step S4 takes into account factors that affect the colors of the printed image and the display image, so that the accuracy of the simulation of the first image F to be printed on the printing medium A in step S5 can be improved.

All the embodiments described above may be combined with each other as long as they do not exclude each other. From the above description, many improvements and other embodiments of the present disclosure are apparent to those skilled in the art. Accordingly, the above description should be interpreted only as an example, and is provided for the purpose of teaching those skilled in the art the best mode for carrying out the present disclosure. Details of the structure and/or the function can be substantially changed without departing from the spirit of the present disclosure.

### INDUSTRIAL APPLICABILITY

The present disclosure can be applied to a printing apparatus capable of improving the accuracy of simulating a printed image, a control method for the printing apparatus, a computer program, and a printing system.

What is claimed is:

1. A printing apparatus comprising:
a display device;
a controller; and
a memory configured to store computer-readable instructions that, when executed by the controller, perform processes including:
a first acquisition operation of acquiring first image data for printing a first image on a printing medium using an ink ejected from a nozzle;
a first color conversion operation of performing color conversion on the first image data to generate second image data;
a second color conversion operation of performing, according to a display condition when displaying the first image on the display device, color conversion on the second image data to generate third image data; and
a display operation of displaying a second image on the display device based on the third image data, and
wherein in the first color conversion operation, the color conversion is performed according to any one of a printing medium, a printing condition, and a combination of the printing medium and the printing condition.

2. The printing apparatus according to claim 1,
wherein the first color conversion operation includes performing the color conversion such that the second image displayed on the display device becomes darker as an ejection amount of ink when printing the first image based on the first image data increases.

3. The printing apparatus according to claim 2,
wherein as the ejection amount of ink when printing the first image based on the first image data increases, the first color conversion operation incudes varying any one of hue of the second image data, lightness of the second image data, saturation of the second image data, a combination of the hue and the lightness, a combination of the lightness and the saturation, a combination of the saturation and the hue, and a combination of the hue, the lightness and the saturation,
wherein varying the hue includes varying a hue angle,
wherein varying the lightness includes lowing the lightness, and
wherein varying the saturation includes moving the saturation away from an origin of a Lab color space.

4. The printing apparatus according to claim 1,
wherein the first color conversion operation includes performing the color conversion such that the second image displayed on the display device becomes darker as printing resolution when printing the first image based on the first image data becomes higher.

5. The printing apparatus according to claim 4,
wherein as the printing resolution when printing the first image based on the first image data becomes higher, the first color conversion operation includes varying any one of hue of the second image data, lightness of the second image data, saturation of the second image data, a combination of the hue and the lightness, a combination of the lightness and the saturation, a combination of the saturation and the hue, and a combination of the hue, the lightness and the saturation,
wherein varying the hue includes varying a hue angle,
wherein varying the lightness includes lowing the lightness, and
wherein varying the saturation includes moving the saturation away from an origin of a Lab color space.

6. The printing apparatus according to claim 1,
wherein the first color conversion operation includes performing the color conversion such that saturation of the second image data becomes higher as types of ink when printing the first image based on the first image data increases.

7. The printing apparatus according to claim 1,
wherein the first color conversion operation includes performing the color conversion such that when types of ink to be used for printing the first image based on the first image data are predetermined basic colors and chromatic colors other than the basic colors, saturation of the second image data is higher than when types of ink are only the basic colors.

8. The printing apparatus according to claim 1,
wherein the first color conversion operation includes performing the color conversion such that when printing the first image based on the first image data on a base formed by ejecting a base ink onto a surface of the printing medium, the second image displayed on the display device becomes darker than when printing the first image based on the first image data on the surface of the printing medium without the base.

9. The printing apparatus according to claim 8,
wherein when printing the first image based on the first image data on a base formed by ejecting a base ink onto a surface of the printing medium, the first color conversion operation includes varying any one of hue of the second image data, lightness of the second image data, saturation of the second image data, a combination of the hue and the lightness, a combination of the lightness and the saturation, a combination of the saturation and the hue, and a combination of the hue, the lightness and the saturation, from a case when printing the first image based on the first image data on the surface of the printing medium without the base,
wherein varying the hue includes varying a hue angle,
wherein varying the lightness includes lowing the lightness, and
wherein varying the saturation includes moving the saturation away from an origin of a Lab color space.

10. The printing apparatus according to claim 1,
wherein the first color conversion operation includes performing the color conversion such that when printing the first image based on the first image data on a base formed by ejecting a base ink onto a surface of the printing medium, the second image displayed on the display device becomes darker as an ejection amount of the base ink increases.

11. The printing apparatus according to claim 10,
wherein when printing the first image based on the first image data on a base formed by ejecting a base ink onto a surface of the printing medium, as the ejection amount of the base ink increases, the first color conversion operation includes varying any one of hue of the second image data, lightness of the second image data, saturation of the second image data, a combination of the hue and the lightness, a combination of the lightness and the saturation, a combination of the saturation and the hue, and a combination of the hue, the lightness and the saturation,
wherein varying the hue includes varying a hue angle,
wherein varying the lightness includes lowing the lightness, and
wherein varying the saturation includes moving the saturation away from an origin of a Lab color space.

12. The printing apparatus according to claim 1,
wherein the controller is configured to execute performing a second acquisition, the second acquisition includes acquiring a color gamut that is printable on the printing medium by an ink ejected from the nozzle, and
wherein, for a pixel that is outside the color gamut after the first image data is color converted in the first color conversion operation, the second color conversion operation includes assigning a special color value indicating that the pixel is outside the color gamut, and generating the second image data.

13. A control method for a printing apparatus comprising:
causing a printing apparatus including a display device to execute
a first acquisition operation of acquiring first image data for printing a first image on a printing medium using an ink ejected from a nozzle,
a first color conversion operation of performing color conversion on the first image data to generate second image data,
a second color conversion operation of performing, according to a display condition when displaying the first image on the display device, color conversion on the second image data to generate third image data, and
a display operation of displaying a second image on the display device based on the third image data,
wherein in the first color conversion operation, the color conversion is performed according to any one of the printing medium, a printing condition, and a combination of the printing medium and the printing condition.

14. A non-transitory computer readable storage medium storing a computer program that causes a computer of a printing apparatus including a display device, the program comprising:
a first acquisition operation of acquiring first image data for printing a first image on a printing medium using an ink ejected from a nozzle;
a first color conversion operation of performing color conversion on the first image data to generate second image data;
a second color conversion operation of performing, according to a display condition when displaying the first image on the display device, color conversion on the second image data to generate third image data; and
a display operation of displaying a second image on the display device based on the third image data,
wherein in the first color conversion operation, the color conversion is performed according to any one of the printing medium, a printing condition, and a combination of the printing medium and the printing condition.
